(19) United States
(12) Patent Application Publication
(10) Pub. No.: US 2018/0361826 A1
(43) Pub. Date: Dec. 20, 2018

(54) Controlled Vehicle Heating System

(71) Applicant: Gary Reed, Wauwatose, WI (US)

(72) Inventor: Gary Reed, Wauwatose, WI (US)

(21) Appl. No.: 15/997,179

(22) Filed: Jun. 4, 2018

Related U.S. Application Data
(60) Provisional application No. 62/520,248, filed on Jun. 15, 2017.

(51) Int. Cl. B60H 1/03; B60H 1/22

(52) U.S. Cl. CPC B60H 1/034; B60H 1/2225; B60H 1/2218

(57) ABSTRACT

A heating system for an automobile that selectively produces heat quickly. The controlled vehicle heating system includes a resistive heating element located within the main duct of a vehicle wherein all vents of the vehicle are connected to the main duct. The resistive heating element is connected to the vehicle's electric heating and cooling system and battery. The system includes a control circuit with a temperature sensor designed to monitor the temperature of the engine. The control circuit is operably connected to the resistive heating element and a heater fan within the vehicle. The control circuit is designed to deactivate the resistive heating element and heater fan when a predetermined temperature is reached. A thermostatic actuator is connected to the resistive heating element which allows a user to selectively control the operation of the resistive heating element. The user can then quickly and selectively control the heat of the car.

### CROSS REFERENCE TO RELATED APPLICATIONS

This application claims the benefit of U.S. Provisional Application No. 62/520,248 filed on Jun. 15, 2017. The above identified patent application is herein incorporated by reference in its entirety to provide continuity of disclosure.

### BACKGROUND OF THE INVENTION

The present invention relates to vehicle heating systems. More specifically, the present invention provides a resistive heating element disposed within the ducts of a vehicle connected to all vents of the vehicle. A control circuit is operably connected to the resistive heating element. The control circuit is configured to deactivate the resistive heating element when an engine within the vehicle reaches a predetermined temperature. A thermostatic actuator is affixed to a dashboard within the vehicle, wherein the thermostatic actuator selectively controls the operation of the resistive heating element.

The majority of vehicles require the engine to run for an extended period of time prior to heating up. Unfortunately, this results in the windows of the car taking an extensive time to defrost or defog, and for the temperature inside the vehicle to rise, which leaves a drive feeling uncomfortably cold inside the car and uncomfortable attempting to drive while the windows are occluded. Some drivers will choose to press the gas pedal while the car is parked to heat the engine and vehicle's interior faster, however this can damage the transmission of the car, leading to a cost of thousands of dollars. Additionally, some drivers will install remote starters inside their cars, and sit inside while waiting for the vehicle to heat up. Unfortunately, this leads to excessive pollution from the car while idling and is detrimental to the environment. Thus, an improved controlled vehicle heating system is desired for allowing a person to more easily heat their vehicle in a fast and controlled manner.

### SUMMARY OF THE INVENTION

In view of the foregoing disadvantages inherent in the known types of vehicle heating systems now present in the prior art, the present invention provides a controlled vehicle heating system wherein the same can be utilized for providing convenience for the user when desiring to selectively and quickly control the heating system within their vehicle.

It is therefore an object of the present invention to provide a new and improved vehicle heating system that has all of the advantages of the known art and none of the disadvantages. The present system comprises a resistive heating element disposed within the main duct of a vehicle wherein all vents of the vehicle are connected thereto, such that the resistive heating element is operably connected to the vehicle's existing electric heating and cooling system and powered by the vehicle's battery. Additionally, the controlled vehicle heating system comprises a control circuit having a temperature sensor configured to monitor the temperature of the vehicle engine, wherein the control circuit is operably connected to the resistive heating element and a heater fan of the vehicle. The control circuit is configured to deactivate the resistive heating element and vehicle heater fan when a predetermined temperature is reached. Further, a thermostatic actuator is operably connected to the resistive heating element such that a user can selectively control the operation of the resistive heating element.

In one embodiment, the resistive heating element comprises an electric coil. In another embodiment, the thermostatic actuator selectively controls the operation of the resistive heating element via a binary on-off switch. In a further embodiment, the thermostatic actuator selectively controls the operation of the resistive heating element via a variable switch, such as a dimmer switch. In one embodiment, the thermostatic actuator is affixed to a dashboard of the vehicle.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the resistive heating element disposed within the main duct of a vehicle.

FIG. 2 shows perspective view of an embodiment of the controlled vehicle heating system in use.

FIG. 3 shows a perspective view of an embodiment of the control circuit and thermostatic actuator affixed to a dashboard and operably connected to a heater fan.

FIG. 4 shows a schematic view of an embodiment of the controlled vehicle heating system.

### DETAILED DESCRIPTION OF THE INVENTION

Reference is made herein to the attached drawings. Like reference numerals are used throughout the drawings to depict like or similar elements of the controlled vehicle heating system. The figures are intended for representative purposes only and should not be considered to be limiting in any respect.

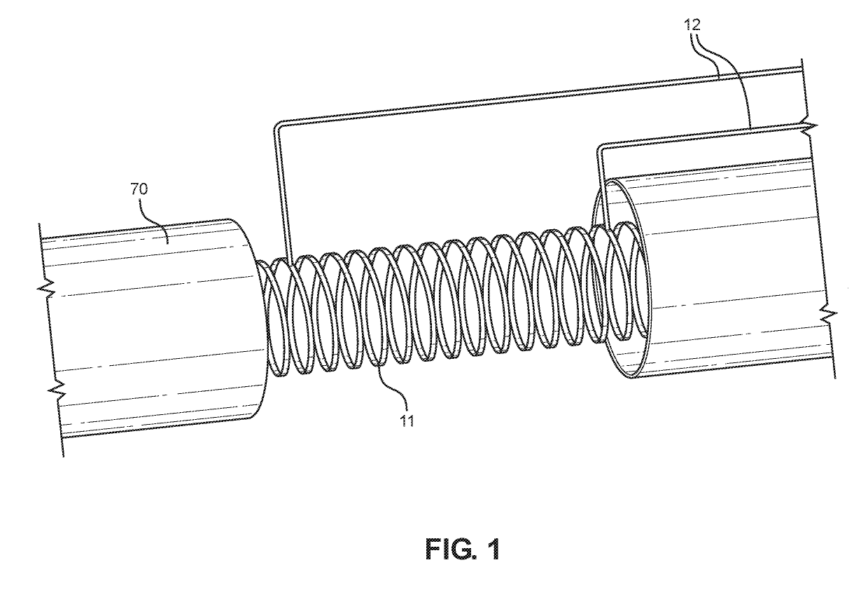

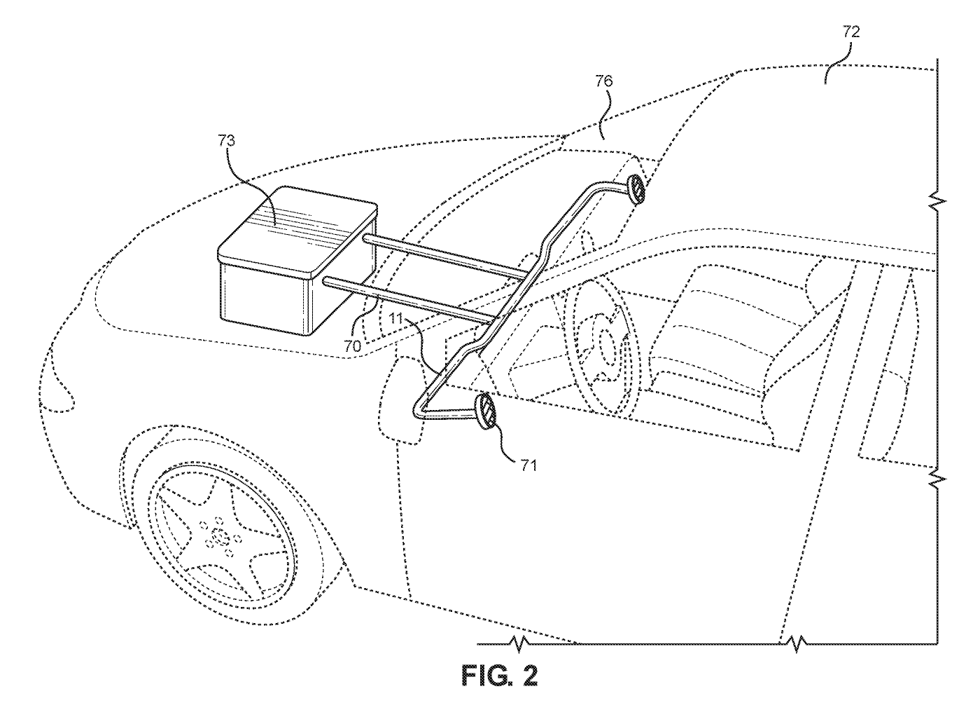

Referring now to FIG. 1 and FIG. 2, there are shown perspective views of embodiments of the resistive heating element disposed within the main duct of a vehicle and the controlled vehicle heating system in use, respectively. A controlled vehicle heating system comprises a resistive heating element 11 disposed within a main duct 70 of a vehicle 72. In one embodiment of the controlled vehicle heating system, the resistive heating element 11 comprises an electric coil. The resistive heating element 11 is disposed in the main duct 70 wherein all vents 71 are connected thereto, such that the resistive heating element 11 is operably connected to an existing electric heating and cooling system of the vehicle 72. In the illustrated embodiment, the resistive heating element 11 is comprises a length of at least two inches and is incorporated into a small portion of the main duct 70. However, in other embodiments, the resistive heating element 11 comprises a length greater than two inches and extends through a substantial portion of the main duct 70.

The resistive heating element is operably connected to a battery 73 of the vehicle 72, thereby providing an instant heat to the vehicle 72 through the vents 71 when the battery is powered. In this way, the wait time for the vehicle 72 to heat up is decreased from the normal wait time, which typically relies on the heat produced by an engine. Thereby, the interior of the vehicle 72 becomes warmer faster. Additionally, when a window 76 is fogged due to the cold air outside the vehicle 72, the heat provided by the controlled vehicle heating system defogs the window 76 faster than the traditional defogging mechanism provided by the engine heat.

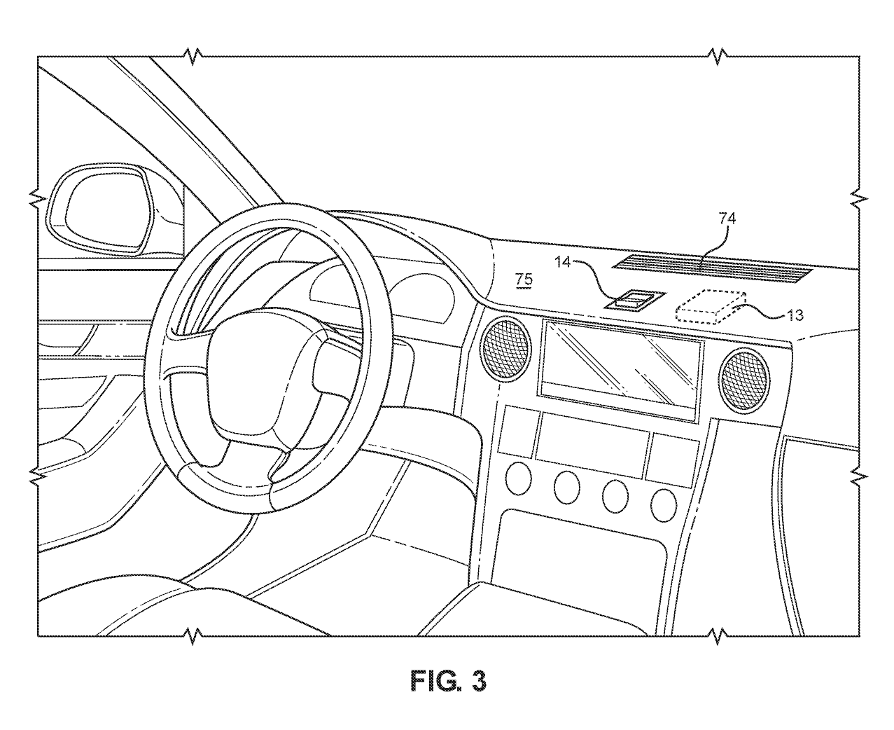

Referring now to FIG. 3, there is shown a perspective view of an embodiment of the control circuit and thermostatic actuator affixed to a dashboard and operably connected to a heater fan. The controlled vehicle heating system further comprises a control circuit 13 having a temperature sensor configured to monitor the temperature of the vehicle engine. The control circuit 13 is operably connected to the resistive heating element via a connection. In the illustrated embodiment, the connection 12 comprises electric wires, however in alternate embodiments, the connection is wireless. Additionally, the control circuit 13 is operably connected to the heater fan 74 of the vehicle 72, such that control circuit 13 can selectively control the heat released into an interior of the vehicle 72. The control circuit 13 is configured to deactivate the resistive heating element 11 and vehicle heating fan 74 when the temperature sensor within the control circuit 13 detects the vehicle engine has reached a predetermined temperature. The control circuit 13 is connected to the engine of the vehicle via an additional connection, which in one embodiment is comprises wires. In this way, the control circuit 13 deactivates the resistive heating element when the vehicle engine reaches the temperature required to conventionally heat the interior of the car.

Additionally, a thermostatic actuator 14 is operably connected to the resistive heating element and control circuit 13 through a connection, such that a user can selectively control the operation of the resistive heating element 11 via triggering the thermostatic actuator 14. In one embodiment, the thermostatic actuator 14 comprises a binary on-off switch. However, in other embodiments, the thermostatic actuator 14 comprises a variable switch, similar to a dimmer switch, such that the thermostatic actuator 14 selectively controls the flow of heat. In an alternate embodiment, the thermostatic actuator 14 comprises a button. In an additional embodiment of the controlled vehicle heating system, the thermostatic actuator 14 is affixed to a dashboard 75 of the vehicle. In this way, the thermostatic actuator 14 is within easy access for an individual such that the resistive heating element 11 can be triggered on demand.

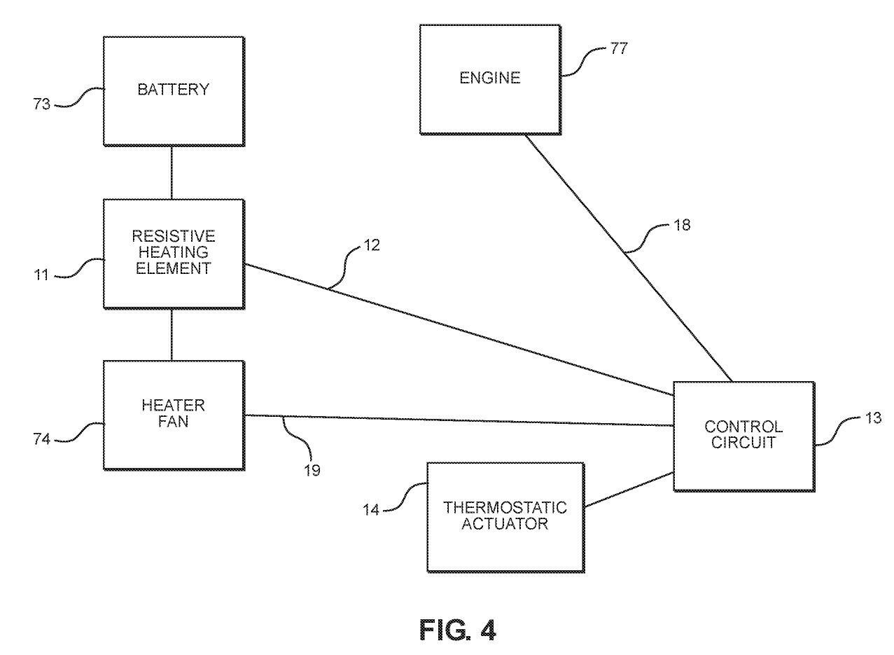

Referring now to FIG. 4, there is shown a schematic view of an embodiment of the controlled vehicle heating system. The control circuit 13 is operably connected to the engine 77 through a connection 18, to the resistive heating element 11 through a connection 12, and to the heater fan 74 through a connection 19. Additionally, the control circuit 13 is in constant communication with the thermostatic actuator 14, such that triggering the thermostatic actuator 14 prompts the resistive heating element 11 to begin drawing power from the battery 73, and additionally actuates the heater fan 74, such that the vehicle 72 begins to heat up, and the heat is dispersed through the vents 75 and into the interior of the vehicle. Further, the control circuit 13 is in constant communication with the engine 77 of the vehicle, such that the resistive heating element 11 is automatically deactivated when the engine 77 reaches a predetermined temperature. In this way, the battery 73 is not overly used and drained of energy.

In operation, the resistive heating element, such as a coil, is installed into a vehicle along with the control circuit and thermostatic actuator, wherein the control circuit and thermostatic actuator are both operably connected to the resistive heating element. In one embodiment, the thermostatic actuator is affixed to the dashboard of the vehicle. The coil is disposed within the main duct of the vehicle, such that the coil is operably connected to all vents of the vehicle. When actuated by the thermostatic actuator, the coil is triggered, and heat is instantly delivered to all vents of the vehicle, such that the windows on the vehicle are quickly defogged and the interior of the vehicle is quickly heated. When the engine of the vehicle reaches a predetermined temperature, the control circuit automatically deactivates the coil, and the traditional heating system utilizing the engine takes over. Should the user desire to turn off the coil prior to the engine fully heating, the thermostatic actuator can be selectively controlled.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A controlled vehicle heating system, comprising:
a resistive heating element disposed within a main duct of a vehicle wherein all vents of the vehicle are connected thereto, such that the resistive heating element is operably connected to an existing electric heating and cooling system of vehicle;
wherein the resistive heating element is operably connected to a battery of the vehicle;
a control circuit having a temperature sensor configured to monitor temperature of the vehicle engine;
wherein the control circuit is operably connected to the resistive heating element;
wherein the control circuit is operably connected to a heater fan of the vehicle;
wherein the control circuit is configured to deactivate the resistive heating element and vehicle heater fan when a predetermined temperature is reached;
a thermostatic actuator operably connected to the resistive heating element such that a user can selectively control the operation of the resistive heating element.

2) The controlled vehicle heating system of claim 1, wherein the resistive heating element comprises an electric coil.

3) The controlled vehicle heating system of claim 1, wherein the thermostatic actuator selectively controls the operation of the resistive heating element in a binary on-off switch.

4) The controlled vehicle heating system of claim 1, wherein the thermostatic actuator selectively controls the flow of heat via a variable actuator.

5) The controlled vehicle heating system of claim 1, wherein the thermostatic actuator is mounted on a dashboard of a vehicle.
